(19) United States
(12) Patent Application Publication
(10) Pub. No.: US 2013/0122508 A1
(43) Pub. Date: May 16, 2013

(54) METHODS AND ARTICLES FOR SAMPLE PROCESSING

(71) Applicants: William Bedingham, Woodbury, MN (US); James E. Aysta, Stillwater, MN (US); Barry W. Robole, Woodville, WI (US); Kenneth B. Wood, Minneapolis, MN (US); Theresa J. Gerten, Inver Grove Heights, MN (US); Christopher R. Kokaisel, Woodbury, MN (US); David J. Franta, Woodbury, MN (US); Kurt J. Halverson, Lake Elmo, MN (US); Joel R. Dufresne, St. Paul, MN (US)

(72) Inventors: William Bedingham, Woodbury, MN (US); James E. Aysta, Stillwater, MN (US); Barry W. Robole, Woodville, WI (US); Kenneth B. Wood, Minneapolis, MN (US); Theresa J. Gerten, Inver Grove Heights, MN (US); Christopher R. Kokaisel, Woodbury, MN (US); David J. Franta, Woodbury, MN (US); Kurt J. Halverson, Lake Elmo, MN (US); Joel R. Dufresne, St. Paul, MN (US)

(73) Assignee: 3M INNOVATIVE PROPERTIES COMPANY, ST. PAUL, MN (US)

(21) Appl. No.: 13/699,761

(22) PCT Filed: May 23, 2011
(86) PCT No.: PCT/US11/37603

§ 371 Date: Jan. 8, 2013

Related U.S. Application Data
(60) Provisional application No. 61/348,813, filed on May 27, 2010.

(51) Int. Cl. G01N 1/28; B01L 3/00

(52) U.S. Cl. CPC G01N 1/28; B01L 3/5027
USPC 435/6.12; 422/502; 436/174; 435/4

(57) ABSTRACT

Methods and devices for the thermal processing of samples are disclosed, including sample processing devices featuring an overflow region for retaining excess fluid, as well as portable sealing apparatuses for occluding channels in a sample processing device.

### BACKGROUND

The present invention relates to the field of sample processing devices. More particularly, the present invention relates to sample processing devices and methods of manufacturing and using the sample processing devices.

Sample processing devices may be used for performing biological or chemical reactions and assays with small volumes of reagent and sample. Some microfluidic devices are described in U.S. Pat. Nos. 6,627,159 B1 (Bedingham et al.); 6,814,935 (Harms et al.); and 7,026,168 (Bedingham et al). The microfluidic devices described in those documents may include laminated structures of a first layer with features such as process chambers and conduits embossed therein, and a second layer, which is typically flat, and forms the backside of the device. Typically, the conduits are used to deliver liquid samples to the process chambers. Reactions are typically carried out in the process chambers. Most often, the progress of the reaction is monitored in these same process chambers via optical techniques such as fluorescence, absorbance, etc. Accordingly, the first layer is typically constructed of transmissive material so that the reaction can be optically interrogated through this layer. The microfluidic devices may be provided with or without carriers as described in the above-identified documents.

The process chambers are often present in arrays, such as in groups of 96 or 384 per device. Such arrays typically correspond to the standard formats in which conventional microtiter plates are available. Alternatively, the process chambers can be present in groupings and/or spacings that are chosen for specific applications or needs. Thermal processing, in and of itself, presents an issue in that the materials used in the devices may need to be robust enough to withstand repeated temperature cycles during, e.g., thermal cycling processes such as PCR. Such cycling may cause excess fluid (e.g., fluid not retained in process chambers) to escape from the loading apparatus of the device. Escaped fluid may result in contamination of a laboratory environment and accordingly run afoul of biosafety protocols.

### SUMMARY

The present disclosure provides for sample processing devices including an overflow region having a volume of at least the volume of excess fluid. The overflow region, in some embodiments, includes a reservoir located between a loading structure and at least one processing chamber. In other embodiments, the overflow region includes a portion of the main conduit that is not occluded during processing of the device. In yet another embodiment, the overflow region includes a portion of the loading chamber or other loading structure that contains a volume of at least the volume of the excess fluid.

In one implementation, sample processing devices of the present invention includes a body that includes a first side attached to a second side, and one or more process arrays formed between the first and second sides. Each process array of the one or more process arrays includes a loading structure; a main conduit including a length; a plurality of process chambers distributed adjacent to the main conduit, wherein the loading structure is in fluid communication with the plurality of process chambers through the main conduit; a deformable seal; and an overflow region having capacity to retain a volume at least the excess volume.

In certain embodiments, the deformable seal includes a deformable portion of the second side of the body, and the deformable seal extends along substantially all of the main conduit.

In some embodiments, the process array includes an inlet port and the overflow region is located between the inlet port and the plurality of process chambers. In certain embodiments, the overflow region is located between the loading structure and the plurality of process chambers. In some embodiment, the overflow region includes at least one reservoir adjacent to the main conduit and in fluid communication with the main conduit. The reservoir is isolated from the main conduit and process chambers when the main conduit is occluded and may include a distal edge portion, the edge portion forming a reservoir offset angle with the main conduit, and wherein the reservoir offset angle is at least 90 degrees. In certain embodiments, the reservoir offset angle is at least 120 degrees.

In some embodiments, the overflow region includes a portion of the main conduit. This portion may be a displaced portion of the main conduit and may include a sinusoidal shape or tortuous path.

In certain embodiments, the overflow region includes at least a portion of the loading structure.

The present disclosure also provides for methods of processing sample materials. In certain embodiments, the method includes providing a sample processing device that includes: a body including a first side attached to a second side; a process array formed between the first and second sides, the process array including a loading structure, a main conduit comprising a length, a plurality of process chambers distributed along the main conduit, wherein the main conduit is in fluid communication with the loading structure and the plurality of process chambers; a deformable seal located between the loading structure and the plurality of process chambers; and an overflow region having capacity to retain a volume at least the excess volume. The method may further include distributing sample material to at least some of the process chambers through the main conduit; closing a first portion of the deformable seal to occlude a first portion of the main conduit proximate the overflow region; and closing a second portion of the deformable seal to occlude a second portion of the main conduit between the overflow region and the loading structure.

In certain embodiments, closing the first and second portions of the deformable seal is done in a continuous manner. In other embodiments, closing the first and second portions of the deformable seal is done in a discontinuous manner. In additional embodiments, the overflow region is not occluded.

The present invention also provides apparatuses for sealing deformable seals in sample processing devices. In certain embodiments, the sealing apparatuses include a base adapted to retain a sample processing device; a slide housing operatively connected to the base and including a staking slide mounted for traversing movement across a surface of the slide housing wherein the base and the slide housing define an elongated body having an open state and a closed state; and one or more sealing structures attached to the staking slide, the sealing structures facing the base, wherein each sealing structure of the one or more sealing structures is adapted to deform at least a portion of the deformable seal as the staking slide traverses the slide housing in the closed state. In some embodiments, the slide housing is hingedly connected to the base. The staking slide may also be enclosed within the slide housing and may travel on a rail or guide on a surface of the slide housing.

In certain embodiments, the sealing apparatus includes a base having a cavity to retain the sample processing device and a first surface; a slide housing operatively connected to the base and a second surface, a staking slide movably mounted on the second surface to traverse at least a portion of the slide housing; and one or more sealing structures attached to the staking slide, the sealing structures facing the base, wherein each sealing structure of the one or more sealing structures is adapted to deform at least a portion of the deformable seals.

The present invention additionally provides systems for processing samples. In certain embodiments, the system includes: a sample processing device including a first and second major surface, wherein the sample processing devices includes at least one deformable seal; a frame adapted to retain the sample processing device, wherein the frame comprises a rail extending across at least a portion of a surface of the frame; a staking slide mounted to traverse along the rail; and sealing structures operatively connected to the staking slide, wherein the sealing structures are adapted to deform at least a portion of the at least one deformable seal and remain in contact with the first and second major surface as the staking slide traverses the rail.

In certain embodiments, the system includes a sample processing device comprising a body that includes a first side attached to a second side, and one or more process arrays formed between the first and second sides, wherein each process array of the one or more process arrays includes: a loading structure; a main conduit including a length; a plurality of process chambers distributed adjacent to the main conduit, wherein the loading structure is in fluid communication with the plurality of process chambers through the main conduit; a deformable seal; and an overflow region having capacity to retain a volume at least the excess volume. The system may further include a sealing apparatus for closing the deformable seals in the sample processing device, the sealing apparatus including: a base adapted to retain a sample processing device; a slide housing operatively connected to the base and comprising a staking slide mounted for traversing movement along a surface of the slide housing, wherein the base and the slide housing define an elongated body having an open state and a closed state; and one or more sealing structures attached to the staking slide, the sealing structures facing the base, wherein each sealing structure of the one or more sealing structures is adapted to deform at least a portion of the deformable seal as the staking slide traverses the slide housing.

The present invention further provides methods for closing deformable seals in a sample processing device. In certain embodiments, the methods include providing a sample processing device including a body that comprises a first side attached to a second side, and one or more process arrays formed between the first and second sides, wherein each process array of the one or more process arrays comprises a loading structure, a main conduit including a length, a plurality of process chambers distributed along the main conduit, wherein the loading structure is in fluid communication with the plurality of process chambers through the main conduit, and a deformable seal located along the main conduit between the loading structure and the plurality of process chambers. The methods may further include locating the sample processing device in a sealing apparatus, the sealing apparatus including a base adapted to retain the sample processing device; a slide housing operatively attached to the base, a staking slide mounted for movement across the slide housing; and one or more sealing structures attached to the staking slide, the one or more sealing structures facing the sample processing device in the base; and closing at least a portion of the deformable seals in the sample processing device located on the base by traversing the slide housing with the staking slide while the sample processing device is located between the base and the bridge, wherein the one or more sealing structures deform at least a portion of the second side of the body to close the deformable seals.

As used in connection with the present invention, the following terms shall have the meanings set forth below.

“Deformable seal” (and variations thereof) means a seal that is deformable under mechanical pressure (with or without a tool) to permanently occlude a conduit along which the deformable seal is located.

“Excess volume” means a volume comprising the difference between the volume of fluid loaded or otherwise introduced into the device prior to processing and the volume of fluid in the processing chambers (and feeder conduits) after the main conduit and/or conduits is/are deformably sealed.

“Thermal processing” (and variations thereof) means controlling (e.g., maintaining, raising, or lowering) the temperature of sample materials to obtain desired reactions. As one form of thermal processing, “thermal cycling” (and variations thereof) means sequentially changing the temperature of sample materials between two or more temperature setpoints to obtain desired reactions. Thermal cycling may involve, e.g., cycling between lower and upper temperatures, cycling between lower, upper, and at least one intermediate temperature, etc.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a process array that comprises “a” feeder conduit can be interpreted to mean that the processing device includes “one or more” feeder conduits.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further described with reference to the drawings, wherein corresponding reference characters indicate corresponding parts throughout the several views, and wherein:

FIG. 1 is a perspective view of a sample processing device according to one embodiment of the present invention.

FIG. 2 is an enlarged view of a portion of one process array on the sample processing device of FIG. 1.

FIG. 3 is a perspective view of a process array of a sample processing device according to one embodiment of the present invention.

FIG. 4 is a cross-sectional view of the process array of FIG. 3.

FIG. 5a is an enlarged view of a portion of one process array according to one embodiment of the present invention.

FIG. 5b is an enlarged view of sample distributed in of the process array of FIG. 5a at some point in time prior to sealing.

FIG. 5c is an enlarged view of a fluid sample distributed in the process array of FIG. 5a at some point in time after sealing.

FIG. 6 is an enlarged view of a process array according to one embodiment of the present invention.

FIG. 7 is an enlarged view of a process array according to one embodiment of the present invention.

FIG. 8 is a cross-sectional view of a portion of the sample processing device of FIG. 7.

FIG. 9 is a cross-sectional view of the portion of the sample processing device of FIG. 8.

FIG. 10 is a cross-sectional view of the main conduit of the sample processing device of FIG. 8, taken after deformation of the main conduit to isolate the process chambers.

FIG. 11 is an exploded perspective view of an assembly including a sample processing device and a carrier according to one embodiment of the present invention.

FIG. 12 is an exploded perspective view of an alternative sample processing device and carrier assembly according to the present invention.

FIG. 13 is a schematic diagram of one sealing apparatus that may be used in connection with the present invention.

FIG. 14 is a perspective view of the apparatus of FIG. 13.

FIG. 15a is a perspective view of a sealing apparatus according to another embodiment of the present invention prior to receiving a sample processing device.

FIG. 15b is another perspective view of the sealing apparatus of FIG. 15a.

FIG. 16 is another perspective view of the sealing apparatus of FIGS. 15a and 15b.

### DETAILED DESCRIPTION OF ILLUSTRATIVE EMBODIMENTS

In the following descriptions of exemplary embodiments of the invention, reference may be made to the accompanying Figures which form a part hereof, and in which are shown, by way of illustration, specific exemplary embodiments in which the invention may be practiced. It is to be understood that other embodiments may be utilized and structural changes may be made without departing from the scope of the present invention.

In some embodiments, the present invention provides a sample processing device that can be used in the processing of liquid sample materials (or sample materials entrained in a liquid) in multiple process chambers to obtain desired reactions, e.g., PCR amplification, ligase chain reaction (LCR), self-sustaining sequence replication, enzyme kinetic studies, homogeneous ligand binding assays, and other chemical, biochemical, or other reactions that may require precise and/or rapid thermal variations. More particularly, the present invention provides sample processing devices that include one or more process arrays, each of which include a loading chamber, a plurality of process chambers, an overflow region, and a main conduit placing the process chambers in fluid communication with the loading chamber.

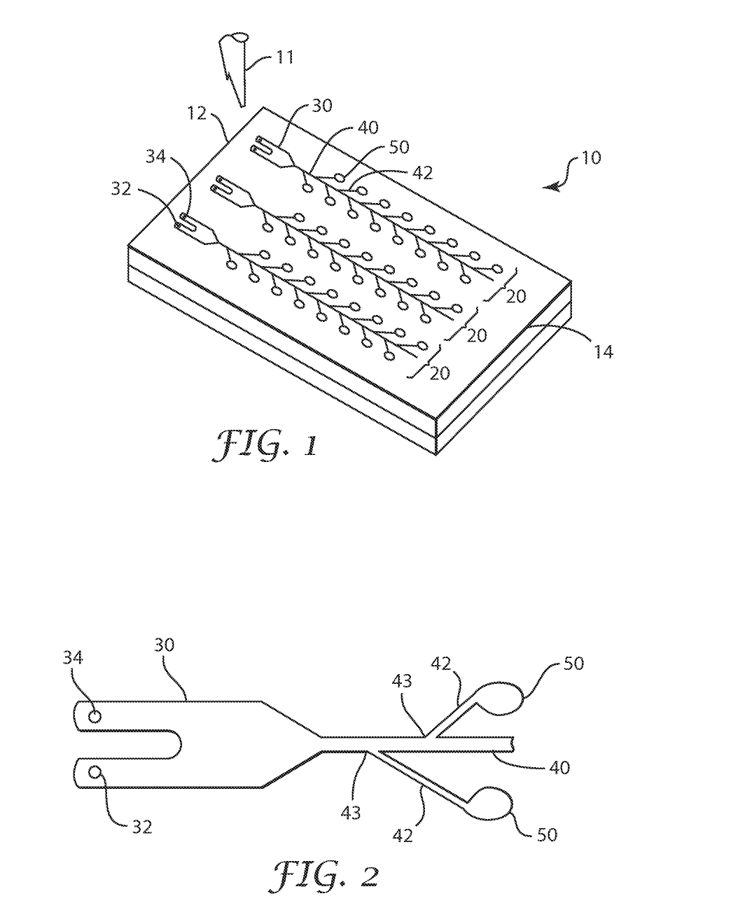

One embodiment of a sample processing device manufactured according to the principles of the present disclosure is illustrated in FIGS. 1 and 2, where FIG. 1 is a perspective view of one sample processing device 10 and FIG. 2 is an enlarged plan view of a portion of the sample processing device. The sample processing device 10 includes at least one, and preferably a plurality, of process arrays 20. Each of the depicted process arrays 20 extends from proximate a first end 12 towards the second end 14 of the sample processing device 10.

The process arrays 20 are depicted as being substantially parallel in their arrangement on the sample processing device 10. Although this arrangement may be suitable, it will be understood that any arrangement of process arrays 20 that results in their substantial alignment between the first and second ends 12 and 14 of the device 10 may alternatively be utilized. For example, a sample processing device may comprise one or more rows of substantially sequential process arrays. In one such embodiment, a first row may include process arrays that extend to a point proximate the loading structure or loading structures of a second row of substantially parallel process arrays. Accordingly, the second row may include process arrays that extend to a point proximate the loading structures of a third row of process arrays, and so on.

The process arrays 20 may be advantageously aligned if the main conduits 40 of the process arrays are to be closed simultaneously as discussed in more detail below. The process arrays 20 may also be aligned if sample materials are to be distributed throughout the sample processing device by rotation about an axis of rotation proximate the first end 12 of the device 10. When so rotated, any sample material located proximate the first end 12 is driven toward the second end 14 by centrifugal forces developed during the rotation.

Each of the process arrays 20 includes at least one main conduit 40, and a plurality of process chambers 50 located along each main conduit 40. The process arrays 20 also include a loading structure 30 in fluid communication with a main conduit 40 to facilitate delivery of sample material to the process chambers 50 through the main conduit 40. As depicted in FIG. 1, each of the process arrays include only one loading structure 30 and only one main conduit 40, though other multi-loading structure/conduit implementations are also contemplated.

The loading structure 30 may be designed to mate with an external apparatus (e.g., a pipette, hollow syringe, or other fluid delivery apparatus) to receive the sample material. The loading structure 30 itself may define a volume or it may define no specific volume, but, instead, be a location at which sample material is to be introduced. For example, the loading structure may be provided in the form of a port through which a pipette or needle is to be inserted. In one embodiment, the loading structure may be, e.g., a designated location along the main conduit that is adapted to receive a pipette, syringe needle, etc.

The process chambers 50 are in fluid communication with the main conduit 40 through feeder conduits 42. As a result, the loading structure 30 in each of the process arrays 20 is in fluid communication with each of the process chambers 50 located along the main conduit 40 leading to the loading structure 30.

If the loading structure 30 is provided in the form of a loading chamber, the loading structure 30 may include an inlet port 32 for receiving sample material into the loading structure 30. The sample material may be delivered to inlet port 32 by any suitable technique and/or equipment, such as, but not limited to, a pipette. The pipette may be operated manually or may be part of an automated sample delivery system for loading the sample material into loading structures 30 of sample processing device 10.

Each of the loading structures 30 depicted in FIG. 1 also includes a vent port 34 with the loading structure 30. The inlet port 32 and the vent port 34 may preferably be located at the opposite ends of the legs of a U-shaped loading chamber as depicted in FIGS. 1 and 2. Locating the inlet port 32 and the vent port 34 at opposite ends of the legs of a U-shaped loading chamber may assist in filling of the loading structure 30 by allowing air to escape during filling of the loading structure 30.

It should be understood, however, that the inlet ports and vent ports in loading structures 30 are optional. In some embodiments, the loading structures may be provided without pre-formed inlet or vent ports. In such a device, sample material may be introduced into the loading structure by piercing the chamber with, e.g., a syringe. It may be desirable to use the syringe or another device to pierce the loading structure in a one location before piercing the loading structure in a second location to fill the chamber. The first opening can then serve as a vent port to allow air (or any other gas) within the loading structure to escape during loading of the sample material.

Each of the process arrays 20 in the sample processing devices 10 of the present invention may be unvented. As used in connection with the present invention, an “unvented” process array is a process array in which the only ports leading into the volume of the process array are located in a loading chamber of the process array. In other words, to reach the process chambers within an unvented process array, sample materials must be delivered through the loading structure. Similarly, any air or other fluid located within the process array before loading with sample material must also escape from the process array through the loading structure. In contrast, a vented process array would include at least one opening or channel outside of the loading structure. That opening would allow for the escape of any air or other fluid located within the process array before loading during distribution of the sample material within the process array.

Methods of distributing sample materials by rotating a sample processing device about an axis of rotation located proximate the loading structures are described in U.S. Pat. No. 6,627,159 (Bedingham et al.). One suitable method includes distribution by centrifugation. It may be desirable that, regardless of the exact method used to deliver sample materials to the process chambers through the main conduits of sample processing devices of the present invention, substantially all of the process chambers, main conduit, and feeder conduits are filled with the sample material.

The process arrays 20 depicted in FIG. 1 are arranged with the process chambers 50 located on both sides of each of the main conduits 40. The process chambers 50 are in fluid communication with the main conduit 40 through feeder conduits 42. The process chambers 50 are generally circular in shape and the feeder conduits 42 entering the process chambers 50 along a tangent. Such an orientation may facilitate filling of the process chambers 50, but other shapes and orientations are contemplated and will be known to one having skill in the art.

The feeder conduits 42 are preferably angled off of the main conduit 40 to form a feeder conduit angle that is the included angle formed between the feeder conduit 42 and the main conduit 40. The feeder conduit angle may be less than 90 degrees, or 45 degrees or less. The feeder conduit angles formed by the feeder conduits 42 may be uniform or they may vary between the different process chambers 50. In another alternative, the feeder conduit angles may vary between the different sides of each of the main conduits 40. For example, the feeder conduit angles on one side of each of the main conduits 40 may be one value while the feeder conduit angles on the other side of the main conduits may be a different value. Additional feeder conduit and process chamber arrangements, as well as loading structure constructions, are described, for example, in U.S. Pat. Nos. 6,627,159 and 7,026,168 (Bedingham et al.)

The sample processing device further includes an overflow region located within each of the process arrays. The overflow region may be any shape and/or path that creates a holding area (i.e., reservoir) between at least a portion of the loading structure and the process chambers. This reservoir and/or holding area can retain at least a portion of the excess volume (i.e., the volume of the fluid introduced less the volume contained in the process chambers and feeder conduits after occlusion of the main conduit) of the sample processing device. Accordingly, the overflow region has the capacity to retain the portion of a fluid sample that exceeds the capacity of the process chambers and at least a portion of the feeder conduits. The overflow region may be, for example, within the loading structure, adjacent the main conduit, or between the loading structure and the process chambers. In some embodiments, at least a portion of the reservoir or holding area is displaced from an axis of the main conduit. As the main conduit is sealed, the excess volume is isolated from the process chambers. The size and location of the overflow region will vary depending on, among other factors, the sample processing application (e.g., the amount of sample material used) and available real estate on the sample processing device.

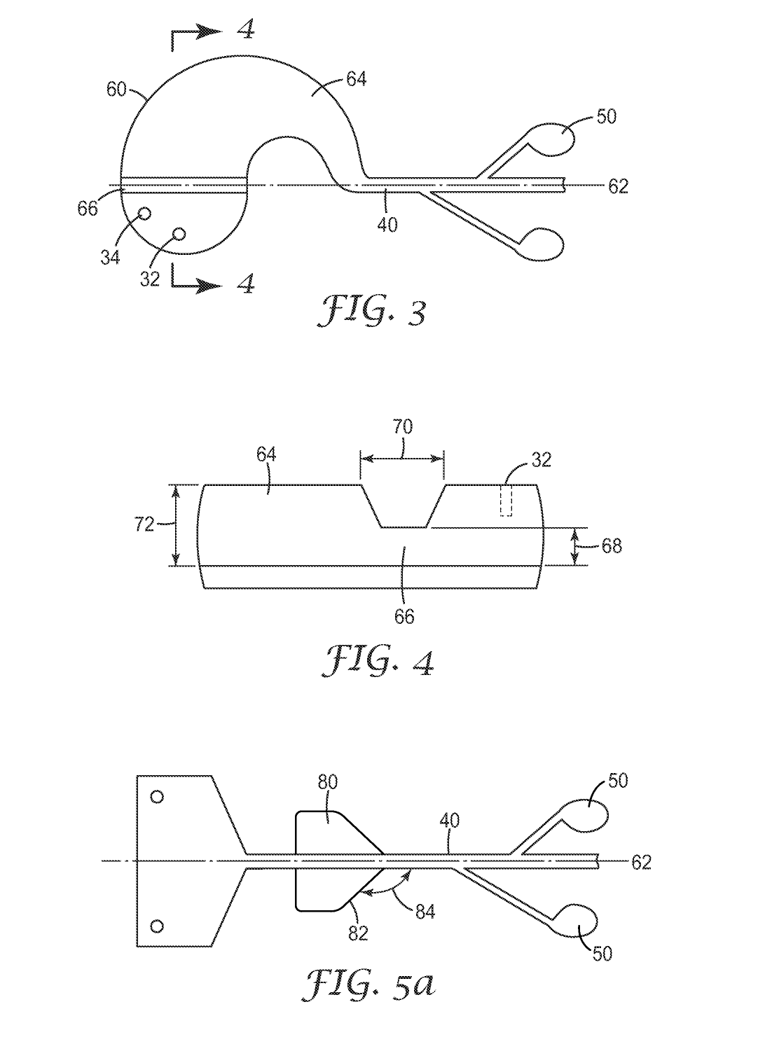

One embodiment of a process array including an overflow region is depicted in FIGS. 3 and 4. In such an embodiment, the overflow region includes a portion of a loading structure 60. The loading structure 60 comprises a kidney-like shape, for example, in that a portion of the loading structure 60 is displaced from an axis 62 of the main conduit 40. The volume of this overflow region 64 of the loading structure 60 is at least the excess volume (i.e., a volume comprising the difference between the volume of fluid loaded or otherwise introduced into the device prior to processing and the volume of fluid in the processing chambers (and feeder conduits) after the main conduit and/or conduits is/are deformably sealed), and may be greater than the excess volume. Other shapes and arrangements are also contemplated, though not depicted.

As depicted in FIGS. 3 and 4, the loading structure 60 includes a sealing channel 66 having a substantially similar height 68 and width 70 as the main conduit 40. This channel 66 extends along an axis 62 of the main conduit 40. Such construction may assist in separating the inlet port 32 from the fluid in the overflow region 64 and may ensure the sealing channel 66 is occluded by a sealing apparatus as described below. In the depicted embodiment, the overflow region 64 of loading structure 60 includes a height 72 greater than the height 68 of the sealing channel 66. In other embodiments, it is contemplated that the height 72 of the overflow region 64 and the sealing channel 66 may be substantially equal, though such a construction may require the overflow region 64 to encompass a greater cross-sectional area.

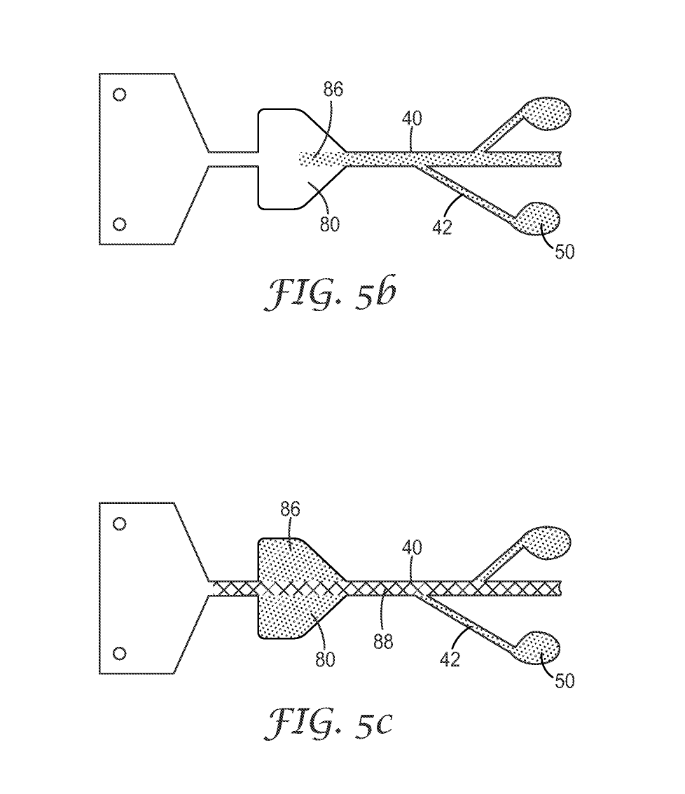

In an alternative embodiment depicted in FIGS. 5a-c, an overflow region 80 is located between the loading structure 30 and the plurality of process chambers 50. The overflow region 80 includes a reservoir in fluid communication with the main conduit 40 prior to sealing. The main conduit 40 may essentially extend through the reservoir, in that the reservoir includes a sealing portion (i.e., a channel) having a substantially similar height and width as the main conduit 40. This portion/channel extends along the axis 62 of the main conduit 40.

To aid fluid flow into the process chambers during initial loading a distal edge portion 82 of the reservoir 80 may be offset at an angle from the main conduit 40, wherein a reservoir offset angle 84 is formed between the edge portion 82 and the main conduit 40. The reservoir offset angle 84 may at least 90 degrees, or alternatively at least 120 degrees.

FIGS. 5b and 5c depict the potential location of an excess volume of fluid in a device including an overflow reservoir 80 at different stages of sample processing. FIG. 5b demonstrates a level of excess fluid 86 after the sample material has been distributed. As depicted, the main conduit 40, feeder conduits 42 and process chambers 50 include fluid sample material. As the main conduit 40 is sealed according to methods further described below, fluid is forced back into the overflow region 80. Once the main conduit is sealed (i.e., occluded) as depicted by closed deformable seal 88 in FIG. 5c, the excess fluid 86 is substantially contained in overflow region 80.

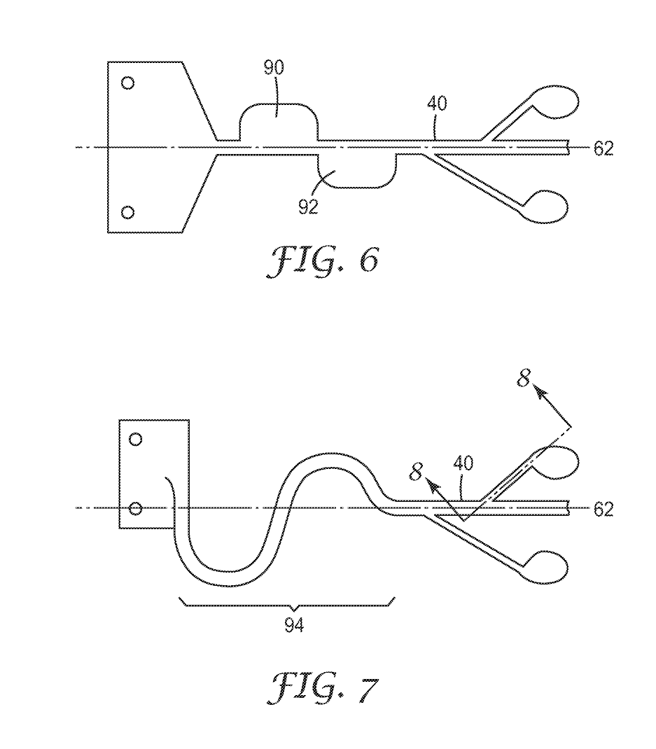

The overflow region may include one or more separate overflow sections in fluid communication with the main conduit prior to sealing. As depicted in FIG. 6, the overflow region includes two offset sections 90, 92 disposed on opposite sides of the main conduit 40. It is also contemplated that, in some embodiments, the overflow region includes one or more sections disposed on the same side of the main conduit.

In another embodiment, the overflow region includes at least one displacement path 94 (i.e., displaced portion) of the main conduit. The displacement path 94 intersects with the axis 62 of the main conduit 40 at least once. As depicted in FIG. 7, the displacement path 94 includes a sinusoidal or otherwise tortuous shape and intersects with the axis 62 of the main conduit 40 twice in between the process chambers and the loading structure. The occlusion of the main conduit 40 at select locations in the overflow region allows for isolation of the fluid in the displacement path 94 adjacent the axis 62. Thus, the volume capacity of the displacement path 94 adjacent the axis 62 may be at least the excess volume, and may be greater than the excess volume.

In some embodiments not depicted here, the overflow region includes a portion of the main conduit between the loading structure and the process chambers nearest the loading structure that is otherwise straight but is not sealed (i.e., occluded) during sample processing. Instead, the sealing of portions of the main conduit proximal and distal to this unsealed portion acts to isolate and retain the excess fluid in the unsealed portion. The volume contained in this unsealed portion of the main conduit may be at least the excess volume and may alternatively be greater than the excess volume of the sample processing device.

It is further contemplated that excess fluid be distributed various combinations of the loading structure, main conduit, and reservoir. In other words, the overflow region may include two or more of the embodiments discussed above. For example, an overflow region may comprise both a portion of the loading structure and a reservoir adjacent the main conduit. In such embodiments, the volume contained in the portion of the loading structure and the volume of reservoir add up to at least the excess volume.

Referring to FIGS. 8-10, process chamber 50 may include a reagent 56. It may be preferred that at least some, and preferably all, of the process chambers 50 in the devices 10 of the present invention contain at least one reagent before any sample material is distributed. The reagent may be fixed within the process chamber 50. The reagent 56 is optional, i.e., sample processing devices 10 of the present invention may or may not include any reagents in the process chambers 50. In another variation, some of the process chambers 50 in a process array may include a reagent 56, while others do not. In yet another variation, different process chambers 50 may contain different reagents. It is further contemplated, though not depicted, that the overflow region may contains reagent. In embodiments wherein the overflow region includes at least two overflow sections, each overflow section may include a reagent, or some may include a regent, while others do not.

All of the structures forming the conduits, overflow region, and process chambers may be provided in a first side 16 while a second side 18 is provided in the form of a generally flat sheet. In such a device, the height of the conduits, overflow region, and process chambers can be measured above the generally flat second side 18.

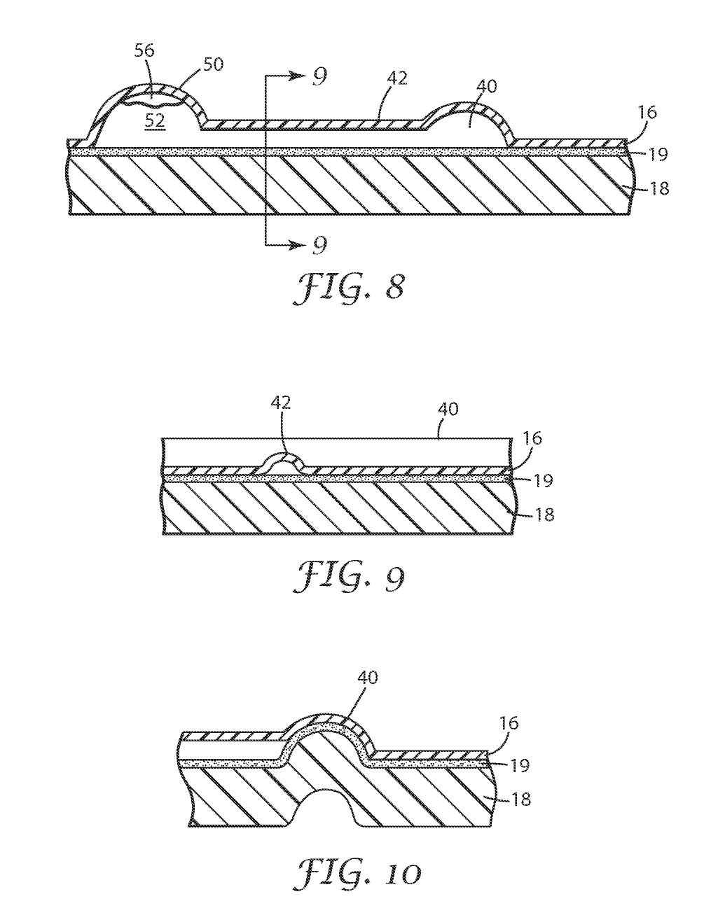

Other features of the sample processing device 10 depicted in FIGS. 8 and 9 are a first side 16 and a second side 18, between which the volume 52 of process chamber 50 is formed. In addition to the process chambers 50, the main conduit 40 and the feeder conduits 42 are also formed between the first and second sides 16 and 18. Although not depicted, the loading structures, e.g., loading chambers, are also formed between the first and second sides 16 and 18 of the sample processing device 10.

The process chamber 50 also defines a volume 52. In sample processing devices of the present invention, the volume 52 of the process chambers may be about 5 microliters or less, alternatively about 2 microliters or less, and, in yet another alternative, about 1 microliter or less. Providing sample processing devices with micro-volume process chambers may be advantageous to reduce the amount of sample material required to load the devices, reduce thermal cycling time by reducing the thermal mass of the sample materials, reducing the size of the overflow region, etc.

The major sides 16 and 18 of the device 10 may be manufactured of any suitable material or materials. Examples of suitable materials include polymeric materials (e.g., polypropylene, polyester, polycarbonate, polyethylene, etc.), metals (e.g., metal foils), etc. In one embodiment, it may be preferred to provide all of the features of the process arrays, such as the loading structures, main conduits, feeder conduits and process chambers in one side of the device, while the opposite side is provided in a generally flat sheet-like configuration. For example, all of the features may be provided in the first side 16 in a polymeric sheet that has been molded, vacuum-formed, or otherwise processed to form the process array features. The second side 18 can then be provided as, e.g., a sheet of metal foil, polymeric material, multi-layer composite, etc. that is attached to the first side to complete formation of the process array features. Suitable materials selected for the sides of the device may exhibit good water barrier properties.

By locating all of the features in one side of the sample processing device 10, the need for aligning the two sides together before attaching them may be eliminated. Furthermore, providing the sample processing device 10 with a flat side may promote intimate contact with, e.g., a thermal block (such as that used in some thermal cycling equipment). In addition, by providing all of the features in one side of the sample processing device, a reduced thermal mass may be achieved for the same process chamber volume. Further, the ability to selectively compress discrete areas about each of the process chambers may be enhanced in devices in which the structure is found on only one side thereof. Alternatively, however, it will be understood that features may be formed in both sides 16 and 18 of sample processing devices according to the present invention.

At least one of the first and second sides 16 and 18 may be constructed of a material or materials that substantially transmit electromagnetic energy of selected wavelengths. For example, suitable materials allow for visual or machine monitoring of fluorescence or color changes within the process chambers 50.

At least one of the first and second sides 16 and 18 may also include a metallic layer, e.g., a metallic foil. If provided as a metallic foil, the side may include a passivation layer on the surfaces that face the interiors of the loading structures 30, main conduits 40, feeder conduits 42, and/or process chambers 50 to prevent contamination of the sample materials by the metal.

As an alternative to a separate passivation layer, an adhesive layer 19 used to attach the first side 16 to the second side 18 may also serve as a passivation layer to prevent contact between the sample materials and any metallic layer in the second side 18. The adhesive may also be beneficial in that it may be conformable. If so, the adhesive may provide enhanced occlusion by filling and/or sealing irregular or rough surface present on either of the two sides.

In the illustrative embodiment of the sample processing device depicted in FIGS. 1 and 8, the first side 16 may be manufactured of a polymeric film (e.g., polypropylene) that is formed to provide structures such as the loading structures 30, main conduit 40, feeder conduits 42, and process chambers 50. The second side 18 may be manufactured of a metallic foil, e.g., an aluminum or other metal foil. The metallic foil may be deformable as discussed in more detail below.

The first and second sides 16 and 18 may be attached to each other by any suitable technique or techniques, e.g., melt bonding, adhesives, combinations of melt bonding and adhesives, etc. Any technique selected should be capable of withstanding the forces generated during processing of any sample materials located in the process chambers 50, e.g., forces developed during distribution of the sample materials, forces developed during thermal processing of the sample materials, etc. Those forces may be large where e.g., the processing involves thermal cycling as in, e.g., polymerase chain reaction and similar processes. It may also be preferred that any adhesives used in connection with the sample processing devices exhibit low fluorescence, be compatible with the processes and materials to be used in connection with sample processing devices.

Particularly useful adhesives exhibit pressure sensitive properties. Such adhesives may be more amenable to high volume production of sample processing devices since they typically do not involve the high temperature bonding processes used in melt bonding, nor do they present the handling problems inherent in use of liquid adhesives, solvent bonding, ultrasonic bonding, and the like. Myriad pressure sensitive adhesives, and methods for their identification and classification, may be found, for example, in U.S. Pat. Nos. 7,026,168 (Bedingham et al.) and 6,730,397 (Melancon et al.).

Another feature of the sample processing devices of the disclosure is a deformable seal that may be used to close the main conduit, isolate the process chambers 50, or accomplish both closure of the main conduit and isolation of the process chambers. As used in connection with the present invention, the deformable seals may be provided in a variety of locations and/or structures incorporated into the sample processing devices.

With respect to FIG. 1, for example, the deformable seal may be located in the main conduit 40 between the loading structure 30 and the plurality of process chambers 50 of each process array 20. In this configuration the deformable seal may extend for the substantially the entire length of the main conduit 40, the entire length of main conduit 40, or it may be limited to selected areas. With respect to the embodiment shown in FIGS. 5a-C, as another example, the deformable seal may extend for the entire length of the main conduit 40, including through the overflow region 80. In one embodiment (not depicted), the deformable seal is located between the process chambers and the overflow region and also between the overflow region and the loading structure. As in embodiments depicted in FIGS. 3 and 4, the deformable seal may extend at least substantially the entire length of the main conduit 40, including the sealing channel 66 of the loading structure 60.

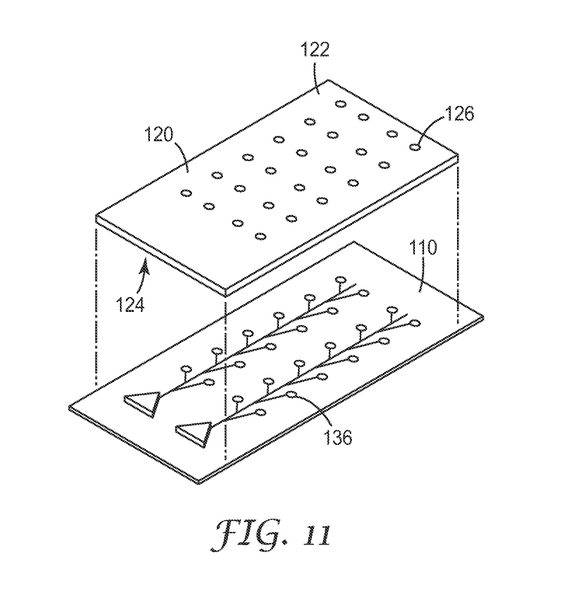

Referring again to FIG. 8, closure of the deformable seals may involve plastic deformation of portions of one or both sides 16 and 18 to occlude the main conduits 40 and/or feeder conduits 42. If, for example, a pressure sensitive adhesive 19 is used to attach the first and second sides 16 and 18 of the sample processing device together, that same pressure sensitive adhesive may help to maintain occlusion of the main conduits 40 and/or feeder conduits 42 by adhering the deformed first and second sides 16 and 18 together as shown in FIG. 10. In addition, any conformability in the adhesive 19 may allow it to conform and/or deform to more completely fill and occlude the main conduits 40 and/or feeder conduits 42.

It may only be required that the deformation restrict flow, migration or diffusion through a conduit or other fluid pathway sufficiently to provide the desired isolation.

Furthermore, occlusion of the main conduit 40 may be continuous over substantially all of the length of the main conduit or it may be accomplished over discrete portions or locations along the length of the main conduit. Also, closure of the deformable seal may be accomplished by occlusion of the feeder conduits alone and/or by occlusion of the feeder conduit/main conduit junctions (in place of, or in addition to, occlusion of a portion or all of the length of the main conduit).

Referring again to FIGS. 8-10, one embodiment of a deformable seal for isolating the process chambers 50 is depicted. The deformable seal is provided in the form of a deformable second side 18 that can be deformed such that it extends into the main conduit 40 as depicted in FIG. 10.

The use of adhesive to attach the first side 16 to the second side 18 may enhance closure or occlusion of the deformable seal by adhering the two sides together within the main conduit 40. A pressure sensitive adhesive may be particularly useful as adhesive 19 in such an embodiment, although a hot melt adhesive may alternatively be used if deformation of the main conduit 40 is accompanied by the application of thermal energy sufficient to activate the hot melt adhesive.

In one method in which the process arrays 20 are closed after distribution of sample materials into process chambers 50, it may be necessary to close the deformable seal along only a portion of the main conduit 40 or, alternatively, the entire length of the main conduit 40. Where only a portion of the main conduit 40 is deformed, it may be preferred to deform that portion of the main conduit 40 located between the loading chamber 30 and the process chambers 50.

Sealing the main conduit 40 by forcing the sides 16 and 18 together along substantially all the length of the conduit 40 may provide advantages such as driving any fluid located in the main conduit 40 back into the overflow region and effectively isolating the inlet port from the excess fluid.

Sample processing devices may be processed alone, e.g., as depicted in FIG. 1. The sample processing device may alternatively be mounted on a carrier. Such an assembly is depicted in an exploded perspective view of sample processing device 110 and carrier 120 in FIG. 11.

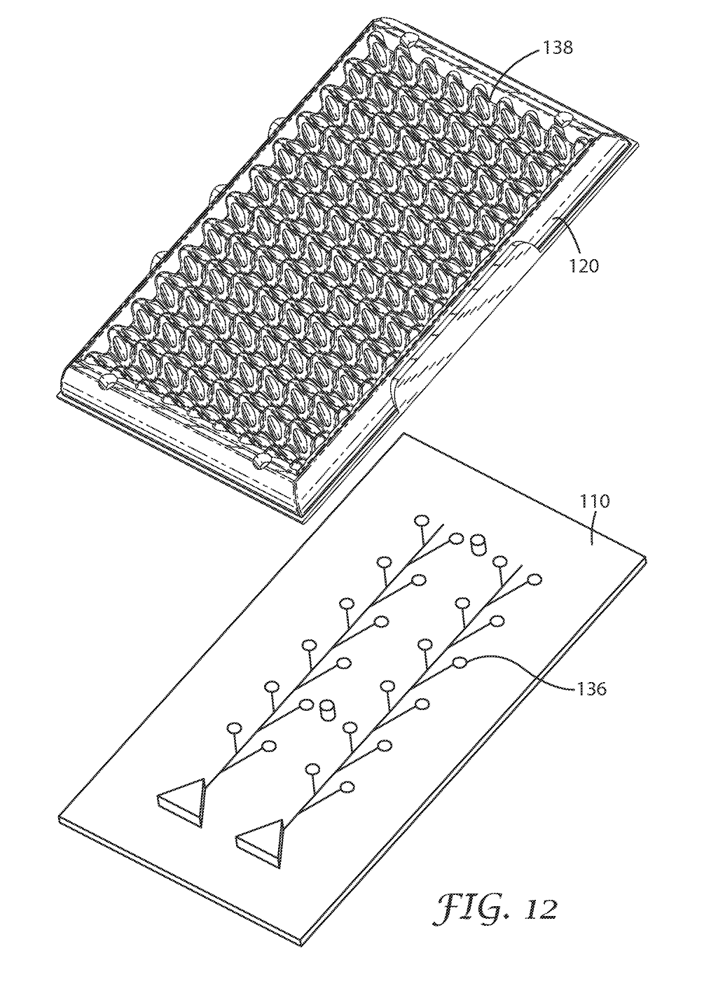

The carrier 120 preferably includes two major surfaces 122 and 124. Major surface 122 faces away from the sample processing device 110 and surface 124 faces towards the sample processing device 110. The carrier 120 also preferably includes through-holes 126 formed therethrough that may be aligned with process chambers 136 in the sample processing 130. The voids 126 may allow for the transmission of light (ultraviolet, visible, infrared, and combinations thereof) into and/or out of the process chambers 136. As seen in FIG. 12, the carrier 120 may also include structures 138 designed to transfer compressive forces to the sample processing device 110 as discussed in a number of the documents identified herein. Additional components and constructions of the carrier may also be found in the aforementioned documents, particularly U.S. Pat. No. 7,026,168 (Bedingham et al.).

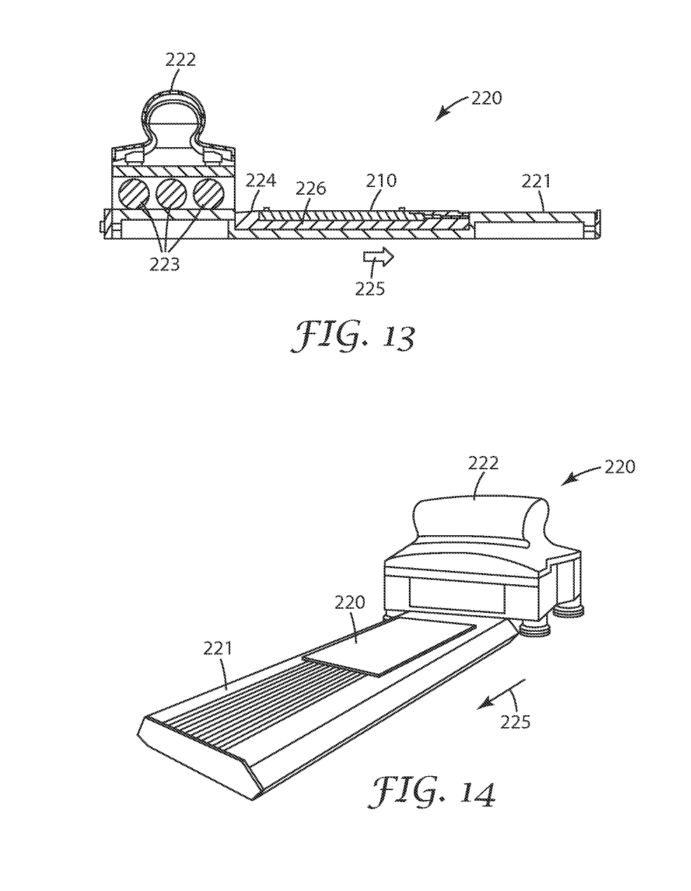

FIGS. 13 and 14 depict various aspects of one apparatus that may be used to isolate the process chambers in a sample processing device of the present invention, where that isolation is achieved by occluding the main conduits and/or the loading structures.

FIG. 13 is a schematic diagram of one sealing apparatus 220 that may be used in connection with the sample processing devices of the present invention. The sealing apparatus 220 is depicted with a sample processing device 210 loaded within bed 224. The depicted sealing apparatus 220 can be used to seal or occlude the process arrays in a sample processing device 210 loaded in bed 224. A device such as sealing apparatus 220 may be particularly useful with sample processing devices that include a set of parallel main conduits that can be sealed or occluded by deforming a portion of the sample processing devices as discussed above in various embodiments.

The sealing apparatus 220 includes a base 221 and a bridge 222 that is traversed across a portion of the base 221 in the direction of arrow 225. The bridge 222 includes, in the depicted embodiment, a series of rollers 223 designed to seal or occlude portions of the process arrays by compressing the sample processing device within the bed 224.

The bed 224 may be constructed of a variety of materials, although it may be preferred that the bed 224 include a layer or layers of a resilient or elastomeric material that provides some support to the sample processing devices and that can also providing some compressibility in response to the forces generated as the bridge 222 is traversed across the sample processing device 220.

The bed 224 includes a cavity 226 into which the sample processing device 210 is situated such that the upper surface of the sample processing device 210 is generally coplanar with the remainder of the bed 224. The cavity 226 may be relatively simple in shape where the sample processing device 210 includes a carrier as described above. In those situations, the carrier may preferably include main conduit support rails that are located underneath each of the main conduits and support the main conduits as the rollers 223 traverse the sample processing device 210. If no carrier is present, or if the carrier used does not include support rails for the main conduits, a shaped bed 224 can include support rails for the portions of the sample processing device to be compressed by the rollers 223.

In an alternative implementation, the bed 224 may include a rigid surface and a plurality of apertures. Apertures may correspond to the location of process chambers on a sample processing device 210. The rigid surface may further include apertures that correspond to at least a portion of the feeder conduits. The alternative bed may further include a series of alignment structures to position the process chambers (and optionally feeder conduits) above the plurality of corresponding apertures. The sample processing device 210 may be placed in bed so that the deformable side is exposed and the structures forming the process array face the rigid surface.

Sealing of the main conduits in the sample processing device 210 is accomplished by traversing the bridge 222 across the sample processing device 210 in the direction of arrow 225. As the bridge 222 is moved, the rollers 223 rotated across the surface of the sample processing device 210 to affect the sealing of the main conduits in the sample processing device 210. Although the sealing apparatus 220 is depicted as including a series of rollers 223, it will be understood that the rollers could be replaced by other structural members such as pins, wires, styli, blades, etc., that, rather than rolling across the sample processing device 210, are drawn across the sample processing device 210 in a sliding motion, The bridge may include at least one styli that mirrors the location of at least one main conduit the as bridge moves across the sample processing device surface.

In the embodiment of a sealing apparatus that includes a bed 224 having a plurality of apertures, sealing of the main conduits of the sample processing device 210 may be accomplished in a similar manner, though the effect on the sample processing device is markedly different. As the sealing structures (preferably rollers) are drawn across the sample processing device, the process arrays are compressed or otherwise forced against the rigid surface of the bed 224. This compressive force may be enough to crush or otherwise completely deform the main conduit and any other structure protruding from the side of sample processing device facing the bed 224. The plurality of process chambers (and optionally feeder conduit portions), however, are forced into the plurality of apertures and may be thus unaffected by the compressive force of the sealing structures.

The rollers 223 (or other sealing structures) may be mounted within the bridge 222 in a variety of manners. For example, the rollers 223 may be fixedly mounted within the bridge, such that their height relative to the base 210 is fixed. Alternatively, one or more of the rollers 223 may be mounted in a suspension apparatus such that the height of the rollers 223 can vary in response to forces generated during sealing. If suspended, the portions of the rollers responsible for sealing each of the main conduits in a sample processing device 210 may be individually suspended such that each portion of the roller can move independently of other portions of the roller. As an alternative to individually suspended portions of the rollers 223, it may be preferred that each roller 223 depicted in FIG. 13 be provided as a one-piece cylindrical unit with structures formed on its surface that provide the desired sealing capabilities.

The rollers or other sealing structures, e.g., pins, blades, etc., may be manufactured of a variety of materials depending on the construction of the sample processing devices to be sealed. The sealing structures may, for example, be constructed of elastomeric coated rollers or other structures, they may be coated with low surface energy materials to reduce friction, they may be constructed entirely of rigid materials (e.g., metals, rigid polymers, etc.). Further, where multiple sealing structures are used (such as a plurality of styli), the different sealing structures may be constructed of a variety of materials, some rigid, some resilient, some including rigid and resilient portions. Additional components and constructions of the sealing apparatus 220 may also be found in the aforementioned documents, particularly U.S. Pat. No. 7,026,168 (Bedingham et al.).

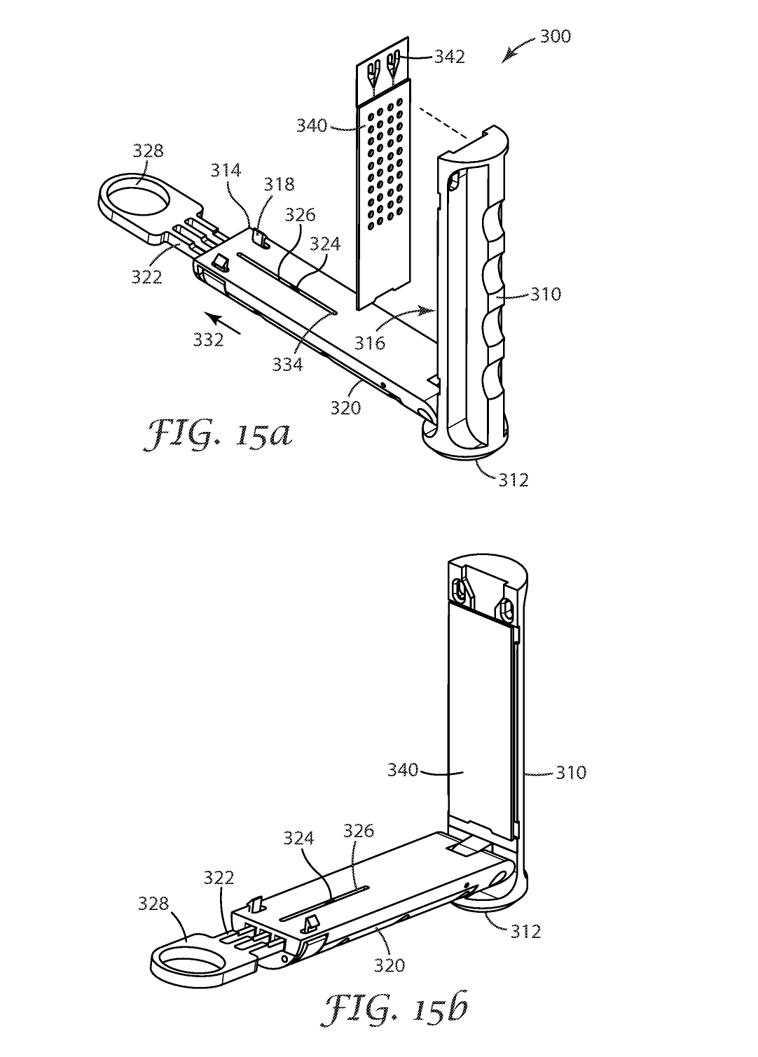

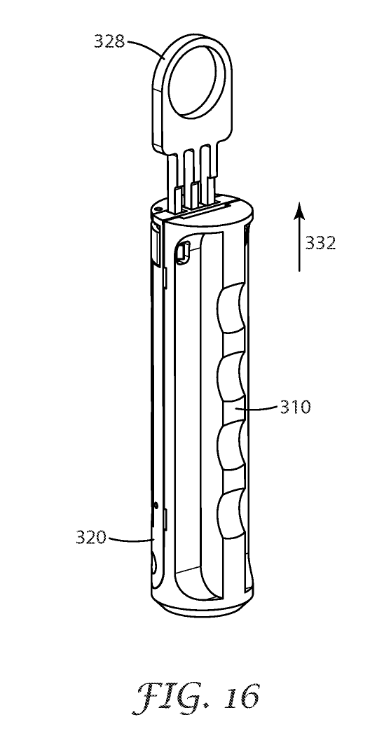

FIGS. 15a, 15b and 16 depict an additional apparatus for use in closing deformable seals. The sealing apparatus 300 includes a base 310 and a slide housing 320 operatively connected to the base 310 proximate the first end 312. In one aspect as depicted in FIGS. 15a and 15b, the slid housing is hingedly connected to the base 310, allowing the sealing apparatus to be opened and closed quickly for simplified access to the sample processing device 340. The sealing apparatus 300 is depicted in an open position in FIGS. 15a and 15b. Optionally, the sealing apparatus 300 may include a locking mechanism 318 proximate the second end 314 to secure slide housing 320 relative to base 310 during sample processing. Such a locking mechanism may include mating features on the slide housing 320 and base 310 or may comprise a ring that may be placed around the periphery of sealing apparatus to prevent the apparatus from opening. The sealing apparatus is depicted in a closed and locked position in FIG. 16.

Base 310 includes a bed 316 for receiving the sample processing device 340. The bed 316 is preferably resilient and may include alignment structures (such as support rails) to secure sample processing devices with and without a carrier. The alignment structures (not depicted) operate to align one or more sealing structures on the staking slide with a portion of a main conduit of the inserted sample processing device 340. The sample processing device 340 is placed in the bed 316 with the deformable surface facing the slide housing 320 and the one or more sealing structures 324.

The slide housing 320 includes a staking slide 322 adapted to traverse movement across or within the slide housing 320 from a first position 334 in staking slot 326 to a final staking position. The staking slide 322 includes one or more sealing structures 324 (e.g., styli, blades, etc.). The staking slide 322 may be elongated and may terminate beyond the bridge 320 in staking fixture 328. The staking fixture 328 thus extends past second end 314 and may be gripped by hand or robotic means to effect movement of the staking slide 322 in direction 332. Movement of the staking slide 322 thus draws the sealing structures 324 across the deformable surface of the sample processing device.

In one embodiment, the staking slide 322 traverses the slide housing 320 along guide rails on a surface of the slide housing 320. Alternatively, the slide housing 320 may include a channel or recess having substantially the same dimensions as the staking slide 322. Guide rails or other alignment structure may be provided within this channel. In such an embodiment, the a portion of the staking slide 322 is enclosed in the slide housing and may optionally have slots or other mating features that allow for travel along the guide rails within the slide housing 320. The sealing structure(s) 324 align with and protrude from staking slot 326. The staking slide 322 may thus be moved within this channel, thereby drawing the sealing structure(s) 324 along the length of staking slot 326. In another alternative, the staking slide 322 may travel along guide rails on base 310.

The sealing apparatus 300 may be designed with the same overall dimensions as a 50 ml centrifuge tube when in the sealing apparatus is in the closed position. The loading structures 342 of the sample processing device 340 may optionally protrude beyond one of the base 310 or slide housing 320. This exposure may allow for sample material to be loaded into the loading structure 342 while the sample processing device 340 is disposed inside the closed sealing apparatus 300.

In one exemplary method of sample processing using sealing apparatus 300, a sample processing device is inserted into base 310 with a fluid sample loaded into a loading structure 342. It is also contemplated that the fluid sample is loaded into a loading structure 342 or otherwise inserted into a process array of the sample processing device after insertion into base 310. Sealing apparatus 300 is then brought to a closed position, optionally with the locking mechanism actuated. The sealing apparatus 300 and sample processing device are placed in a centrifuge and rotated, causing the fluid sample to migrate through the distribution channel to the plurality of process chambers. Upon removal from the centrifuge, the staking slide 322 is drawn across the deformable surface of the sample processing device by moving fixture 328 in a direction away from the first end 334 of staking slot 326. The sample processing device may then be removed and subject to further analysis and processing (e.g., thermal cycling) as described above.

### Embodiments

Exemplary sample processing devices and methods of processing sample materials include the following embodiments:

1. A sample processing device comprising:

a body that comprises a first side attached to a second side, and one or more process arrays formed between the first and second sides, wherein each process array of the one or more process arrays includes:
a loading structure;
a main conduit comprising a length;
a plurality of process chambers distributed adjacent to the main conduit, wherein the loading structure is in fluid communication with the plurality of process chambers through the main conduit;
a deformable seal; and
an overflow region having capacity to retain a volume of at least the excess volume.
   2. The sample processing device of embodiment 1, wherein the overflow region is located between the loading structure and the plurality of process chambers.
   3. The sample processing device of embodiment 2, wherein the overflow region comprises at least one reservoir adjacent to the main conduit and in fluid communication with the main conduit.
   4. The sample processing device of embodiment 3, wherein the reservoir is configured to be isolated from the main conduit and process chambers when the main conduit is occluded.
   5. The sample processing device of embodiment 3, wherein the reservoir comprises a distal edge portion, the edge portion forming a reservoir offset angle with the main conduit, and wherein the reservoir offset angle is at least 90 degrees.
   6. The sample processing device of embodiment 5, wherein the reservoir offset angle is at least 120 degrees.
   7. The sample processing device of any one of the preceding embodiments, wherein the overflow region comprises a portion of the main conduit.
   8. The sample processing device of embodiment 7, wherein the main conduit comprises a central axis and wherein the overflow region comprises a portion of the main conduit displaced from the central axis.
   9. The sample processing device of embodiment 8, wherein the displaced portion of the main conduit comprises a sinusoidal shape or tortuous path.
   10. The sample processing device according to any of the preceding embodiments, wherein the deformable seal comprises a deformable portion of second side of the body, and wherein the deformable seal extends along substantially all of the length of the main conduit.
   11. The sample processing device according to any one of embodiments 3-6, wherein the at least one reservoir comprises a first height and the main conduit comprises a second height, and wherein the first height is greater than the second.
   12. The sample processing device of any of the previous embodiments, wherein the overflow region comprises at least a portion of the loading structure.
   13. The sample processing device of embodiment 12, wherein the loading structure comprises a sealing channel and a reservoir.
   14. The sample processing device of any one of embodiments 12-13, wherein the main conduit comprises a height above a first side of the sample processing device, and the sealing channel comprises a height that is the same or substantially similar to the height of the main conduit.
   15. The sample processing device of any one of embodiments 1-14, wherein the process array comprises an inlet port, and wherein the overflow region is located between the inlet port and the plurality of process chambers.
   16. A method of processing sample materials, the method comprising:

providing a sample processing device that comprises:

a body comprising a first side attached to a second side;

a process array formed between the first and second sides, the process array comprising a loading structure, a main conduit comprising a length and an overflow region, a plurality of process chambers distributed along the main conduit, wherein the main conduit is in fluid communication with the loading structure and the plurality of process chambers;

a deformable seal located between the loading structure and the plurality of process chambers; and

an overflow region having capacity to retain a volume of at least the excess volume;

distributing sample material to at least some of the process chambers through the main conduit; and

closing a first portion of the deformable seal to occlude a first portion of the main conduit proximate the overflow region; and closing a second portion of the deformable seal to occlude a second portion of the main conduit between the overflow region and the loading structure.

17. The method of embodiment 16, wherein closing the first and second portions of the deformable seal comprises continuously closing the first and second portion.
18. The method of embodiment 16, wherein closing the first and second portions of the deformable seal comprises discontinuously closing the first and second portion.
19. The method of embodiment 16, wherein closing the first and second portions of the deformable seal does not occlude the overflow region.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A sample processing device comprising:
a body that comprises a first side attached to a second side, and one or more process arrays formed between the first and second sides, wherein each process array of the one or more process arrays includes:
a loading structure;
a main conduit comprising a length;
a plurality of process chambers distributed adjacent to the main conduit, wherein the loading structure is in fluid communication with the plurality of process chambers through the main conduit;
a deformable seal; and
an overflow region having capacity to retain a volume of at least the excess volume.

2. The sample processing device of claim 1, wherein the overflow region is located between the loading structure and the plurality of process chambers.

3. The sample processing device of claim 2, wherein the overflow region comprises at least one reservoir adjacent to the main conduit and in fluid communication with the main conduit.

4. The sample processing device of claim 3, wherein the reservoir is configured to be isolated from the main conduit and process chambers when the main conduit is occluded.

5. The sample processing device of claim 3, wherein the reservoir comprises a distal edge portion, the edge portion forming a reservoir offset angle with the main conduit, and wherein the reservoir offset angle is at least 90 degrees.

6. The sample processing device of claim 5, wherein the reservoir offset angle is at least 120 degrees.

7. The sample processing device of claim 1, wherein the overflow region comprises a portion of the main conduit.

8. The sample processing device of claim 7 wherein the main conduit comprises a central axis and wherein the overflow region comprises a portion of the main conduit displaced from the central axis.

9. The sample processing device of claim 8, wherein the displaced portion of the main conduit comprises a sinusoidal shape or tortuous path.

10. The sample processing device of claim 1, wherein the deformable seal comprises a deformable portion of second side of the body, and wherein the deformable seal extends along substantially all of the length of the main conduit.

11. The sample processing device of claim 3, wherein the at least one reservoir comprises a first height and the main conduit comprises a second height, and wherein the first height greater is than the second.

12. The sample processing device of claim 1, wherein the overflow region comprises at least a portion of the loading structure.

13. The sample processing device of claim 12, wherein the loading structure comprises a sealing channel and a reservoir.

14. The sample processing device of claim 12, wherein the main conduit comprises a height above a first side of the sample processing device, and the sealing channel comprises a height that is the same or substantially similar to the height of the main conduit.

15. The sample processing device of claim 1, wherein the process array comprises an inlet port, and wherein the overflow region is located between the inlet port and the plurality of process chambers.

16. A method of processing sample materials, the method comprising:
providing a sample processing device that comprises:
a body comprising a first side attached to a second side;
a process array formed between the first and second sides, the process array comprising a loading structure, a main conduit comprising a length and an overflow region, a plurality of process chambers distributed along the main conduit, wherein the main conduit is in fluid communication with the loading structure and the plurality of process chambers;
a deformable seal located between the loading structure and the plurality of process chambers; and
an overflow region having capacity to retain a volume at least the excess volume;
distributing sample material to at least some of the process chambers through the main conduit; and
closing a first portion of the deformable seal to occlude a first portion of the main conduit proximate the overflow region; and closing a second portion of the deformable seal to occlude a second portion of the main conduit between the overflow region and the loading structure.

17. The method of claim 16, wherein closing the first and second portions of the deformable seal comprises continuously closing the first and second portion.

18. The method of claim 16, wherein closing the first and second portions of the deformable seal comprises discontinuously closing the first and second portion.

19. The method of claim 16, wherein closing the first and second portions of the deformable seal does not occlude the overflow region.
